(19) United States
(12) Patent Application Publication
(10) Pub. No.: US 2013/0325694 A1
(43) Pub. Date: Dec. 5, 2013

(54) METHOD AND SYSTEM FOR FINANCING SELF-SUFFICIENT ENERGY SYSTEMS

(71) Applicants: Caisey HARLINGTEN, Erpingham (GB); Randall W. MARUSYK, Ottawa (CA)

(72) Inventors: Caisey HARLINGTEN, Erpingham (GB); Randall W. MARUSYK, Ottawa (CA)

(21) Appl. No.: 13/910,324

(22) Filed: Jun. 5, 2013

Related U.S. Application Data
(60) Provisional application No. 61/655,962, filed on Jun. 5, 2012.

(30) Foreign Application Priority Data
Aug. 3, 2012 (CA) 2784635
Aug. 3, 2012 (CA) 2784642

(51) Int. Cl. G06Q 40/02

(52) U.S. Cl. CPC G06Q 40/025
USPC 705/38

(57) ABSTRACT

An object of the present invention is to provide a method for financing the conversion of an entity from a traditional energy system to a self-sufficient energy system having the following steps: receiving the conversion cost of the self-sufficient energy system; receiving the energy cost of the traditional energy system, the energy cost determined over at least one interval; amortizing the conversion cost of the self-sufficient energy system over the at least one interval to generate an amortized interval cost; comparing the amortized interval cost to the energy cost of the traditional energy system to determine a cost ratio; comparing the cost ratio to a predetermined cost threshold; and approving the financing of the conversion of the entity from the traditional energy system to the self-sufficient energy system if the cost ratio is less than or equal to the predetermined cost threshold.

### FIELD OF THE INVENTION

The present invention pertains to the field of finance management and in particular to a method of financing the conversion of a traditional energy system to a self-sufficient home energy system for a variety of applications.

### BACKGROUND

Energy consumption is a fundamental reality of modern society and as the human population grows and achieves a higher level of technological development, energy consumption continues to increase.

However, it is commonly accepted that it is desirable to reduce energy consumption as much as possible and further to source as much energy from self-sustaining or green sources in order to reduce dependence on traditional non-renewable sources of energy such as oil, natural gas and nuclear power. It is also generally desirable to reduce the economic costs associated with energy consumption; whether viewed from a perspective of extraction, generation, transmission, usage or disposal of unwanted byproducts, among other related aspects of energy consumption.

Such traditional non-renewable sources of energy can have significant environmental impacts related to atmospheric pollution, ground water pollution, thermal pollution and noise pollution among other deleterious environmental impacts. Further, the process of extracting such traditional sources of energy from the environment can also have a serious environmental impact.

Furthermore, as can be readily appreciated, any significant infrastructure upgrade is typically quite expensive. This significant up-front capital expense creates a barrier that often delays or discourages any conversion from older technology to newer technology. This can particularly be the case when the new technology employed is novel or relatively untested.

There are considerable environmental and economic incentives to switch from traditional sources of energy such as those mentioned above to non-traditional self-sustaining sources of energy such as solar panels, wind turbines, tidal generators and geothermal heating systems, among other self-sustaining sources of energy.

Predominately, the consumption of energy at the likes of a household (such as a community building, apartment building, office building, condominium complex, etc.) is achieved by electricity (or other energy forms converted to electricity) supplied to a household and the like from a central distribution system such as the regional electrical power grid.

The consumer of electricity typically purchases energy via monthly billing, typically based upon metered use. For example, a household has an electric use meter that monitors consumption of electricity on a monthly basis. A bill for the use of the electricity for that month is paid by the consumer and is usually consistent month after month. As a further example, a condo complex comprising numerous units consumes electricity (or natural gas for cooking and heating) for use on a monthly or quarterly basis or some other regular basis. Other billing cycles are anticipated based on making regular payments for consumption.

There is therefore a need for a system and method for financing conversion from traditional energy systems to self-sustaining energy systems to minimize the capital expense associated with inherent conversion costs.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method for financing self-sufficient energy systems. In accordance with an aspect of the present invention, there is provided a method for financing the conversion of an entity from a traditional energy system to a self-sufficient energy system having the following steps: receiving the conversion cost of the self-sufficient energy system; receiving the energy cost of the traditional energy system, the energy cost determined over at least one interval; amortizing the conversion cost of the self-sufficient energy system over the at least one interval to generate an amortized interval cost; comparing the amortized interval cost to the energy cost of the traditional energy system to determine a cost ratio; comparing the cost ratio to a predetermined cost threshold; approving the financing of the conversion of the entity from the traditional energy system to the self-sufficient energy system if the cost ratio is less than or equal to the predetermined cost threshold; and declining the financing of the conversion of the entity from the traditional energy system to the self-sufficient energy system, if the cost ratio is greater than the predetermined cost threshold.

In accordance with another aspect of the present invention, there is provided a system for financing the conversion of an entity from a traditional energy system to a self-sufficient energy system having the following: communication means configured to receive the conversion cost of the self-sufficient energy system; communication means configured to receive the energy cost of the traditional energy system, the energy cost determined over at least one interval; calculation means configured to amortize the conversion cost of the self-sufficient energy system over the at least one interval to generate an amortized interval cost; and comparison means configured to evaluate the interval cost to the energy cost of the traditional energy system to determine a cost ratio with a predetermined cost threshold for approval.

### BRIEF DESCRIPTION OF THE FIGURES

FIG. 1 illustrates a flowchart of the steps included in one embodiment of financing the conversion of traditional energy system to a self-sufficient energy system;

### DETAILED DESCRIPTION OF THE INVENTION

### Definitions

Unless defined otherwise, all technical and scientific terms used herein have the same meaning as commonly understood by one of ordinary skill in the art to which this invention belongs.

A “self-sufficient” energy system may be defined as any system which requires no external purchase/trade of energy to conduct energy generation. Examples of such self-sufficient home energy systems could include solar panels; wind turbines; biogas recovery; biomass combustion; nuclear, gas turbine, steam turbine, co-generation and hydroelectric generation facilities; hydrogen generation, storage and combustion and/or reconstitution facilities; and ammonia (NH₃) generation or other chemical based storage generation, storage, combustion and/or reconstitution facilities, among any other suitable self-sufficient home energy systems that will readily be understood by a person skilled in the art. It may also be contemplated by a person skilled in the art that any future self-sufficient energy systems may be adapted to the present disclosure for operation of the method and system.

### Method Overview

The present invention provides for a financing method that acts as a catalyst for any self-sufficient technology to increase the speed at which the disruptive technology replaces the existing traditional technology with respect to energy systems. For example, the financing method could be in the adoption of green technology such as energy generation and consumption, recycling, heating, storage, destruction and the like.

Alternatively, the financing method could be for the adoption of green technology involved in transportation. Further as an alternative, the financing method may serve for the production, harvesting and preparation of food. Other consumer products or services presently provided via a central delivery system are also anticipated by the present invention.

In accordance with an aspect of the present invention, there is provided a method for financing the conversion of a various types of settings from traditional energy systems to self-sufficient energy systems including both house-hold and community level conversions.

### Household Embodiment

One embodiment of the present invention involves a system and method for financing the conversion of an entity, namely a household, from a traditional energy system to a self-sufficient home energy system. For example, the use of solar cells to generate electricity that in turn, uses the electricity to generate hydrogen to store the power, that in turn is converted back to electricity when needed by the household are known in the market.

An element of the present disclosure requires that the consumer in the consumer market need not undergo a significant change in their spending habits for their present lifestyle to adopt the new incumbent technology.

For example, a consuming household may spend $200 per month on electricity for the monthly electrical needs of the home. While spending may be lower in spring and fall months (less heat and/or air conditioning required) it may be higher during summer and winter months; but for the present example for this invention, it can be assumed an average of $200 per month. As such, a typical household does not readily (nor in many circumstances, cannot) have money to spend in switching from an existing technology to a self-sufficient technology unless the monthly spending for the electric stays constant or the self-sufficient technology is nominal to purchase and install, if the installation of a self-sufficient home energy system costs thousands or tens of thousands of dollars, a typical household will not be incentivized to switch.

The present disclosure provides for a financing method and system to allow the consumer to purchase, for example, a self-sufficient home energy system while not experiencing any significant change in their monthly spending amounts. The cost of purchasing a self-sufficient home energy system can vary depending on the quality of a self-sufficient home energy system which can be $10,000 or $50,000, or $70,000, or higher. The present method provides for a system to finance the purchasing of a self-sufficient home energy system by amortizing the costs over a predetermined period (i.e.: X years) at Y%. The result is the consumer of a self-sufficient energy system does not have any change in their monthly spending as they switch from an existing technology to a self-sufficient technology.

A particular embodiment of the present method involves a consumer financing method that finances the switch from the traditional power grid delivery of electricity to a household, to a self-sufficient energy system for the delivery of electricity to a household. When a household, for example, is spending $200 per month on electricity delivered to the house via the traditional electrical power grid, the present invention provides for a method of financing the switch by some form of amortization of the purchase cost of the self-sufficient home energy system. If the self-sufficient home energy system costs $40,000 to purchase and install, the present invention provides for the financing of the $40,000 over, for example, 25 years at for example, 5.24% yielding a monthly cost to the consumer of about $236 per month. This is a net increase of $36 per month that would have to absorbed by the consumer as not significant, subsidized through public or private grants or tax incentives or brought back to $200 per month over time by lowering the $40,000 self-sufficient home energy system cost or offsetting the $36 through other energy savings to the consumer (see below regarding the factoring in of gasoline/petrol costs or natural gas heating or cooking costs).

The financing method could work in conjunction with public or private incentive programs that could bring the monthly cost closer to the consumers current monthly cost for electricity, equal to, or lower than said monthly costs. Moreover, the financing system can set the interest rate, amortization period or the cost of the self-sufficient home energy system to provide the consumer with no change to their monthly electrical bill. Yet further, the financing system can be adjusted to set the interest rate, amortization period, or the cost of the self-sufficient home energy system to provide the consumer with no change to their monthly electrical bill & monthly gasoline/petrol bill as the consumer switches from gasoline/petrol based vehicles to electric based vehicles. This gasoline/petrol bill allows for greater flexibility for the financing system to operate as the combining of the electrical and gasoline/petrol bills into one energy bill allows for a wider variety of options of amortization period and interest rates. This combining of gasoline/petrol bill concept can also be applied to natural gas costs used by a consumer for heating and cooking.

As discussed above, the present disclosure provides a method and system for financing the conversion of an entity (e.g., household) from a traditional energy system to a self-sufficient energy system. In the present embodiment, a household is contemplated as ranging from an individual, 1 bedroom apartment to detached family dwelling, a farm property or a condominium building, among other types of households that will readily appreciated by the skilled person. In some embodiments, it may be possible to include multiple households and classify them as a single household if the boundaries behave similar to that of a single household with a singular energy input and energy output and corresponding cost input and cost output.

It is further contemplated that the present disclosure provides a method which assists a household in converting from a traditional energy system having more expensive energy costs to a self-sufficient home energy system which has equal or lesser amortization costs with compared to a pre-defined threshold. The threshold starts at the current traditional cost interval but may fluctuate depending on a pre-defined percentage. In this way, it is possible that a household can undertake such transition without experiencing any negative economic impacts despite the potentially high costs in acquiring and installing the self-sufficient home energy system, as discussed above.

In the present context, traditional energy systems are contemplated as systems for generating and distributing energy derived from traditional energy sources. Examples of such traditional energy sources include, but are not limited to, electrical energy provided from a regional grid and generated from nuclear power, solar, natural gas, wind, hydroelectric or oil; thermal energy generated from natural gas, solar, geothermal, electricity, oil, biomass or wood burning; among any other suitable energy systems that would readily be understood by the skilled person.

In the present context, self-sufficient energy systems may be contemplated as any energy system that could be operated by an entity (e.g., household) such that the entity could independently own, operate, and maintain the system in order to eliminate its dependence on a larger traditional electricity grid or natural gas distribution system, among other types of traditional energy systems. Examples of such self-sufficient home energy systems could include solar panels; wind turbines; biogas recovery; biomass combustion; nuclear, gas turbine, steam turbine, co-generation and hydroelectric generation facilities; hydrogen generation, storage and combustion and/or reconstitution facilities; and ammonia (NH₃) generation, storage, combustion and/or reconstitution facilities, among any other suitable self-sufficient home energy systems that will readily be understood by the skilled person.

There is a current cost level for self-sufficient energy systems. This cost level should be reduced through improvements in research and production for the given technology. In this way, it is contemplated that one skilled in the art could soundly predict that a conversion to self-sufficient technology based on a reduction in the cost level.

In a similar fashion, there is a current efficiency level for self-sufficient energy systems. This efficiency level should be increased through improvements in research and production for the given technology. In this way, it is contemplated that one skilled in the art could soundly predict that a conversion to self-sufficient technology based on an increase in the efficiency level.

Furthermore, one skilled in the art could soundly predict that a conversion to self-sufficient technology based on a reduction in the cost level, an increase in the efficiency level, or both. Therefore, an advance in technology allowing for more cost effective solutions or more energy efficient solutions provide larger incentives to adopt the proposed self-sufficient home energy system.

In the present context, determining the cost of a self-sufficient energy system is contemplated as a determination of all relevant costs associated with replacing a traditional energy system with a self-sufficient energy system, as will be readily appreciated by the skilled person. Examples of such relevant costs could include costs of installation of new equipment and removal of obsolete equipment, costs of acquiring or leasing land, costs of fuel, costs of acquiring specific equipment or infrastructure, costs of distribution, contracting costs, professional or government fees, costs of operation and maintenance of the self-sufficient system, among any other suitable and relevant costs.

In the present context, amortizing the cost of the self-sufficient energy system is contemplated as determining the cost of the self-sufficient energy system and amortizing that cost over any suitable time period. Amortizing is understood to mean the decrease of the remaining capital cost over this time period as each subsequent interval payment is made, as would be readily understood by the skilled person. The time period could be any suitable time period ranging from weeks to decades, depending on the needs of the instant application for the present method.

In the present context, an interval payment is contemplated to be a payment undertaken at any suitable interval during the time period discussed above. Examples of suitable intervals could be weekly, bi-weekly, monthly, bi-monthly, bi-annually, or annually, among any other suitable interval that may be desirable.

In the present context, a return on investment (“ROI”) is contemplated to be a rate of return on monies invested in the conversion from the traditional energy system to the self-sufficient energy system, as will be readily understood by the skilled person. As such, the rate of return with respect to this investment will be calculated based on the cost savings that will be incurred when the interval payment is less than or equal to the cost of energy as supplied by the traditional energy system over the same interval.

In one example, if the interval payment is 95% of the cost of energy supplied by the traditional energy system over the same interval, the ROI could be considered 5%. In other words, in one embodiment the ROI could be considered the savings incurred during the interval. In other embodiments, the ROI could be calculated in considerably more complicated manners depending on the requirements of the instant application, as will be readily understood by the skilled person.

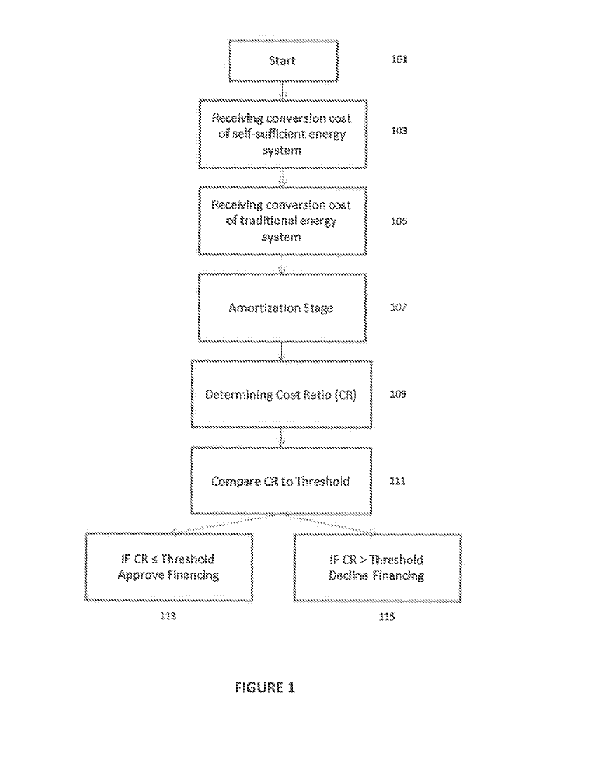

Turning to FIG. 1, at least one embodiment of a method for financing the conversion of the household from a traditional energy system to the self-sufficient home energy system is illustrated, The method starts (101) and proceeds to next step where the cost of conversion for the self-sufficient energy system is received (103). This step could be performed by any interested party, including the members of the household, a third party consultant, a financial institution (e.g., banks, credit unions, investment firms, trust companies, insurance companies, investment banks, brokerage firms, and the like), an equipment supplier, among any other suitable party that may have an interest in the conversion of a household from a traditional energy system to a self-sufficient home energy system.

Subsequently, the cost of the current traditional system in received by the interested party (105). The cost of the current traditional system is determined over a suitable interval (e.g., monthly). The receiving of the data at steps (103)(105) may be accomplished by a communication means including by written instruction, electronic means (e.g., email, instant messaging, social media messaging, voice over internet protocol, and any other means used electronically to transfer data), oral instruction in person or over telephone.

Once the cost of the self-sufficient home energy system is determined, the method proceeds to step where the cost of the self-sufficient home energy system, determined previously, is amortized over a suitable time period (107). Moreover, a suitable interval period is also chosen such that an interval payment can be calculated. This step can be completed by any suitable entity, such as a financial institution or a member of the household, and can be conducted based on any suitable practices known to the skilled person having the appropriate knowledge regarding such financial practices.

The next step of the method involves comparing the interval payments for the amortized cost of the self-sufficient home energy system (determined previously) to the known cost of energy supplied by the traditional energy system over the same interval period; this is known as the cost ratio (109). This known cost of energy supplied by the traditional energy system can be determined based on currently known costs or drawn from historical data, among other arrangements that will be readily apparent to the skilled person.

In this way, the financial viability can be determined of the present method by comparing the cost of energy sourced over an interval period from either a traditional energy system or a self-sufficient home energy system (cost ratio).

In some embodiments, the cost ratio must be less than the current energy cost. In other embodiments, the cost ratio may be valued higher the current energy cost within a pre-defined threshold from the current known energy cost. In some instances this pre-determined threshold may be 0%, 5%, 10%, 20%, etc. This allows for a comparison stage where the cost ratio is evaluated against the traditional energy cost fixed with the pre-defined threshold (111).

At this stage, if the cost ratio is less than or equal to the traditional energy interval cost including the pre-defined threshold, the method/system allows for the approval of financing for the conversion (113). Else, if the cost ratio is greater than the traditional energy cost and outside the allowance percentage set by the pre-defined threshold, the method/system declines authorization for financing for the conversion (115).

In the present context, conversion can include purchasing, installing, maintaining, renting, leasing, retrofitting or any other activity that would be considered part of the process of converting a household from a traditional energy system to a self-sufficient home energy system.

In some embodiments, an additional return of investment (ROI) is calculated. If, during the comparison stage, the cost ratio is less than the current energy value, the method and system proceed to the calculation of ROI.

The ROI is then calculated based on the determination made previously at the comparison stage. The ROI can be calculated in any number of ways depending on the financial and practical realities of the instant application. As will be understood by the skilled person, ROI can be calculated in a number of ways depending on the constraints of the project, however in one example the ROI could be calculated as the percentage cost savings incurred over a chosen time period when the community converts from a traditional energy system to a self-sustaining energy system. However, other manners in which the ROI can be calculated are also contemplated that will be readily understood by the skilled person.

Following calculation of the ROI, the present method proceeds whereby financing for the conversion of the community to the self-sufficient energy system is procured based on the ROI.

### Community Embodiment

Another embodiment of the present invention involves a method for financing the conversion of a community from a traditional energy system to a self-sustaining energy system. Therefore the entity shifts from a household to a community. In the present context, a community is contemplated as ranging from as small as two dwellings to as large as a large metropolitan city. It is further contemplated that the present disclosure provides a method and system which assists a community in raising the necessary financing to transition from a traditional energy system having more expensive energy costs to a self-sustaining energy system which has equal or lesser energy costs. In this way, it is possible that a community can undertake such transition without experiencing any negative economic impacts despite the potentially high costs in acquiring and installing the self-sustaining energy system, as discussed above.

In the present context, determining the cost of a self-sustaining energy system is contemplated as a determination of all relevant costs associated with replacing a traditional energy system with a self-sustaining energy system, as will be readily appreciated by the skilled person. Examples of such relevant costs could include costs of installation of new equipment and removal of obsolete equipment, costs of acquiring or leasing land, costs of fuel, costs of acquiring specific equipment or infrastructure, costs of distribution, contracting costs, professional or government fees, costs of operation and maintenance, among any other suitable and relevant costs.

In the present context, amortizing the cost of the self-sustaining energy system is contemplated as determining the cost of the self-sustaining energy system and amortizing that cost over any suitable time period. Amortizing is understood to mean the decrease of the remaining capital cost over this time period as each subsequent interval payment is made, as would be readily understood by the skilled person. The time period could be any suitable time period ranging from weeks to decades, depending on the needs of the instant application.

In the present context, an interval payment is contemplated to be a payment undertaken at any suitable interval during the time period discussed above. Examples of suitable intervals could be weekly, bi weekly, monthly, bimonthly, biannually, or annually, among any other suitable interval that may be desirable.

In the present context, a return on investment (“ROI”) is contemplated to be a rate of return on monies invested in the conversion from the traditional energy system to the self-sufficient energy system, as will be readily understood by the skilled person. As such, the rate of return with respect to this investment will be calculated based on the cost savings that will be incurred when the interval payment is less than or equal to the cost of energy as supplied by the traditional energy system over the same interval.

In one example, if the interval payment is 95% of the cost of energy supplied by the traditional energy system over the same interval, the ROI could be considered 5%. In other words, in one embodiment the ROI could be considered the savings incurred during the interval. In other embodiments, the ROI could be calculated in considerably more complicated manners depending on the requirements of the instant application, as will be readily understood by the skilled person.

An example of one implementation of this method or system involving a conversion of a community from a traditional energy system to a self-sufficient energy system can be described as follows.

This system or method can be performed by any interested party, including the members of the community board, a third party consultant, a financial institution (e.g., banks, credit unions, investment firms, trust companies, bond issuers, insurance companies, investment banks, brokerage firms, and the like), an equipment supplier, among any other suitable party that may have an interest in the conversion of a household from a traditional energy system to a self-sufficient home energy system.

One embodiment of a method for financing the conversion of the community from a traditional energy system to the self-sustaining energy system starts where the cost of the self-sufficient energy system is received. This data may be received directly from the client who is purchasing the conversion, or the data may be received from any third party privy to this information acting on behalf of the client for the conversion. Third parties may include the community government, individual benefactor, non-profit group, a third party consultant, an equipment supplier, among any other suitable party that may have an interest in the conversion of a community from a traditional energy system to a self-sufficient energy system.

The data regarding the traditional energy system cost is also received by the party interested in conversion. This data is converted to a suitable interval for comparison. This information may come directly from the client (e.g., municipal government, property manager, apartment building owner, and the like).

The data may be communicated by any communication means including written instruction, electronic means (e.g., email, instant messaging, social media messaging, voice over internet protocol, and any other means used electronically to transfer data), and oral instruction in person or over telephone.

Once the cost of the self-sufficient energy system is determined, the cost of the self-sustaining energy system, determined previously, is amortized over a suitable time period. Moreover, a suitable interval period is also chosen such that an interval payment can be calculated. This step can be completed by any suitable entity, such as a financial institution, and can be conducted based on any suitable practices known to the skilled person having the appropriate knowledge regarding such financial practices.

Moving forward, the interval payments for the amortized cost of the self-sustaining energy system (determined previously) is compared to the known cost of energy supplied by the traditional energy system over the same interval period. This known cost of energy supplied by the traditional energy system can be determined based on currently known costs or drawn from historical data, among other arrangements that will be readily apparent to the skilled person.

In this way, the financial viability of the present method by comparing the cost of energy sourced over an interval period from either a traditional energy system or a self-sufficient energy system; this ratio is known as the cost ratio.

In some embodiments, the compared value must be less than the current energy cost. In other embodiments, the compared value may be valued higher the current energy cost within a pre-defined threshold from the current known energy cost. In some instances this threshold may be 0%, 5%, 10%, 20%, etc.

At this stage, if the cost ratio is less than or equal to the traditional energy interval cost including the pre-defined threshold, the method/system allows for the approval of financing for the conversion for the community. Else, if the cost ratio is greater than the traditional energy cost and outside the allowance percentage set by the pre-defined threshold, the method/system declines authorization for financing for the conversion for the community.

In some embodiments, an additional return of investment (ROI) is calculated. If, during the comparison stage, the cost ratio is less than the current energy value, the method and system proceed to the calculation of ROI.

The ROI is then calculated based on the determination made previously at the comparison stage. The ROI can be calculated in any number of ways depending on the financial and practical realities of the instant application. As will be understood by the skilled person, ROI can be calculated in a number of ways depending on the constraints of the project, however in one example the ROI could be calculated as the percentage cost savings incurred over a chosen time period when the community converts from a traditional energy system to a self-sustaining energy system. However, other manners in which the ROI can be calculated are also contemplated that will be readily understood by the skilled person.

Following calculation of the ROI, the present method proceeds whereby financing for the conversion of the community to the self-sufficient energy system is procured based on the ROI.

Financing for the conversion of the community to the self-sustaining can be accomplished in any number of suitable manners, such as but not limited to, issuing a municipal or government bond, forming a corporation and having an initial public offering, soliciting individual investors, soliciting banks, mutual funds, or private equity funds, among other suitable manners of publicly or privately securing financing that will be readily understood by the skilled person.

Once financing is secured, the present method and system proceed whereby the financing that has been secured is used to finance the conversion of the community from the traditional energy system to the self-sustaining energy system.

In some embodiments, the entity selected may be a community wherein the community meets predetermined criteria to accomplish a specific goal (e.g., maximize economic benefit). For example, the selection of various entities within an entity (e.g., community) may be selected based on geographical proximity with respect to one another as to potentially share the self-sufficient technology between the entities in order to reduce the capital cost of conversion.

Various predetermined criteria may be implemented for selection of entities including, but not limited to, similar energy consumption and patterns (e.g., daily usage schedules), geographical proximity of one entity to other entities, geographical proximity of the one or more entities to self-sufficient energy systems, environmental conditions for various entities (e.g., temperature may make entities more conducive to certain self-sustaining technologies), geographical conditions for various entities, financial and economic considerations for various entities (e.g., entities in upper-class neighborhood may be eligible for favorable credit), and eligibility to government programs (e.g., entities may qualify for government reimbursement or tax credit based on self-sufficient technology chosen).

Electronic implementation of System and Method

In some embodiments, the specific components and steps taken in the claimed systems and methods may be implemented by electronic means.

For example, the reception of data from the party interested in energy system conversion may be conducted online via a network interface allowing for sending and receiving data. In this way, the party (e.g., a householder) may logon to a financial institution website where the system may utilize an online mechanism (e.g., “Conversion Wizard”) to determine and/or authorize the initiation of the conversion process. This present disclosure may be fully implemented through these electronic means.

In some embodiments, the interfaces may be available through any mobile device known in the art capable of network access. This device may be either wired or wireless. In some embodiments, the device may include a personal computer, tablet, mobile device, mobile phone, television, music player, personal organizer, or any similar electronic network enabled device. In some embodiments, the user device may be wearable technology including, but not limited to, jewelry, watches, and glasses.

In some embodiments, a server is implemented for the interested party implementing the present method and system, where the interested party may include the members of the household, a third party consultant, a financial institution (e.g., banks, credit unions, investment firms, trust companies, insurance companies, investment banks, brokerage firms, and the like), an equipment supplier, among any other suitable party that may have an interest in the conversion of an entity from a traditional energy system to a self-sufficient home energy system. Similarly, the users may use any device, outlined above, to access the server and provide the information necessary to perform the system and method and consequently receive a response in regards to authorization for financing.

The topology for the electronic means may be any known implement known to one skilled in the art. This may include local installation on user devices and servers, or network based topology allowing for remote access.

The present method and system for financing the conversion of an entity from a traditional energy system to a self-sufficient energy system can be illustrated by way of the following embodiments, which are not intended to be viewed as limiting the present disclosure in any way other than when viewed in the context of the attached claims, which recite the scope of the present method in its entirety.

The invention will now be described with reference to specific examples. It will be understood that the following examples are intended to describe embodiments of the invention and are not intended to limit the invention in any way.

### EXAMPLES

### Example 1

### Single Family Detached House

In at least one embodiment, the method begins where the cost of a self-sufficient home energy system is determined for a single family detached home located in a region having a high proportion of sunny days. Initially, the single family detached home is connected to a traditional energy system in the form of, for example, a regional electrical grid and a natural gas distribution system. In this embodiment, the self-sufficient home energy system could be an array of solar panels and associated solar water heater to be installed on the roof of the house, among other possible self-sufficient home energy systems.

Once the cost of the self-sufficient home energy system is determined (for example, $35,000), the method proceeds where this cost is amortized over a predetermined period (for example, 10 years) to calculate an amortization. Further, an appropriate interval can be selected for making the interval payments (for example, monthly). Once these factors have been selected, an interval price can be calculated (for example, $35,000 divided over the course of 120 monthly payments resulting in an interval payment of roughly $292.00 per month). Of course, and as will be readily appreciated by the skilled person, there may be additional financial considerations that may have to be considered when calculating the interval payment, including but not limited to, the cost of borrowing money, inflation, and fuel costs, among other relevant financial considerations.

Following calculation of the interval payment, the method proceeds where the interval payment (for example, $292.00) is compared to the cost of supplying energy from the traditional energy system for the same interval, which in this case is one month. As discussed above, the cost of supplying energy from the traditional energy system can be forecasted based on various economic considerations or culled from historical data. For the present embodiment, the cost for supplying energy from the traditional energy system could for example be $300.00 per month. In this case, the interval payment for the amortized cost of the self-sufficient home energy system is less than the cost of supplying energy from the traditional energy system.

Accordingly, it is demonstrated from an economic perspective that it is viable to convert the household from a traditional energy system to a self-sufficient home energy system, and thus the conversion can take place. As discussed above, this can involve any design work, installation, maintenance, and retro-fitting required, among any other work that must be undertaken to convert the household to the self-sufficient home energy system. At this point, it is contemplated that the household could be wholly disconnected from the traditional energy system, or alternatively, the household could remain connected to the traditional energy system and provide surplus energy from the self-sufficient home energy system to the traditional energy system, among other arrangements.

Accordingly, once it can be demonstrated from an economic perspective that it is viable to convert the household from a traditional energy system to a self-sufficient home energy system, the conversion takes place.

As discussed above, this can involve any design work, installation, maintenance, and retro-fitting required, among any other work that must be undertaken to convert the household to the self-sufficient home energy system. At this point, it is contemplated that the household could be wholly disconnected from the traditional energy system, or alternatively, the household could remain connected to the traditional energy system and provide surplus energy from the self-sufficient home energy system to the traditional energy system, among other arrangements.

### Example 2

### Family Farm

This example illustrates the application of the system for a family farm arrangement.

The cost of a self-sufficient home energy system is determined for a family farm situated on 100 acres and exposed to high winds and producing a large quantity of waste cellulosic plant matter. Initially, the farm is connected to a traditional energy system in the form of a regional electrical grid and a regular supply of diesel provided from a nearby regional fuel depot.

The proposed self-sufficient home energy system could be a number of wind turbine generators and a biomass combustion facility, among other possible self-sufficient home energy systems.

Once the cost of the self-sufficient home energy system is determined (for example, $100,000), the method proceeds where this cost is amortized over a predetermined period (for example, 25 years) to calculate an amortization. Further, an appropriate interval can be selected for making the interval payments (for example, weekly). Once these factors have been selected, an interval price can be calculated (for example, 100,000 divided over the course of 1300 weekly payments resulting in an interval payment of roughly $77.00 per week). As discussed above, there may also be additional financial considerations that may have to be considered when calculating the interval payment.

Following calculation of the interval payment, the method proceeds where the interval payment (for example, $77.00) is compared to the cost of supplying energy from the traditional energy system for the same weekly interval, which can be calculated as discussed above and could, for example, be $120.00 per month. As will readily appreciated, the interval payment for the amortized cost of the self-sufficient home energy system in this case is also less than the cost of supplying energy from the traditional energy system.

Accordingly, it is demonstrated from an economic perspective that it is viable to convert the household from a traditional energy system to a self-sufficient home energy system, and thus the conversion can take place. The conversion involves any design work, installation, maintenance, and retro-fitting required, among any other work that must be undertaken to convert the household to the self-sufficient home energy system.

At this point, it is contemplated that the household could be wholly disconnected from the traditional energy system, or alternatively, the household could remain connected to the traditional energy system and provide surplus energy from the self-sufficient energy system to the traditional energy system, among other arrangements.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

Moreover, the previous detailed description is provided to enable any person skilled in the art to make or use the present invention. Various modifications to those embodiments will be readily apparent to those skilled in the art, and the generic principles defined herein may be applied to other embodiments without departing from the spirit or scope of the invention described herein. Thus, the present invention is not intended to be limited to the embodiments shown herein, but is to be accorded the full scope consistent with the claims, wherein reference to an element in the singular, such as by use of the article “a” or “an” is not intended to mean one and only one unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

### Example 3

Financing the Conversion of a Community to a Self-Sufficient Energy System by Raising Funding through an Initial Public Offering

This example illustrates the conversion of a small city of, for example, 25,000 people from a traditional energy system (such as a regional grid providing electricity produced by coal and thermal heat produced by natural gas) to a self-sufficient energy system (such as a closed, community grid where electricity is provided by wind and solar and thermal energy is provided by electricity).

The determination of the cost of a suitable self-sufficient energy system is performed by a third party consulting firm. Once the consulting firm has determined a cost, the same consulting firm amortizes the cost of the self-sufficient energy system over a suitable period of time. In this way a suitable interval payment can be calculated.

Once the interval payment has been calculated, a comparison is performed between the interval payment for the amortized cost of converting the community to the self-sufficient energy system and the community's projected costs for supplying energy from the traditional energy system over the same interval period.

Once this determination is performed, the consulting firm could calculate an ROI based on the determination performed. Once an ROI is calculated, the corporation can make in initial public offering (IPO) based on the ROI that has been calculated buy the third party consulting firm with the intention of raising funding for the purchase, installation, operation, maintenance and all other associated costs with converting the community to the self-sufficient energy system. The IPO could be open to prospective investors from outside the community, or could alternatively be only open to members of the community, among other suitable arrangements.

Once financing has been secured, the corporation can proceed where the necessary steps are taken to convert the community from a regional grid providing electricity produced by coal and thermal heat produced by natural gas to a closed, community grid where electricity is provided by wind and solar and thermal energy is provided by electricity.

### Example 4

Financing the Conversion of a Community to a Self-Sufficient Energy System by Raising Funding through an Initial Public Offering

This example illustrates a municipal government converting to a self-sufficient energy system.

The municipal government passes a motion indicating that a small community of 1000 people will convert from a traditional energy system (such as a regional grid providing electricity produced by nuclear power and thermal heat produced through a combination of oil and wood burning heaters) to a self-sufficient energy system (such as a closed, community grid providing electricity produced by the combination of a landfill biogas and a pelletized combustion facility and thermal energy produced by a district water heating system).

The municipality commissions a study from a third party to determine the cost of the self-sufficient energy system. Once this study is completed, the cost of the self-sufficient energy system can be amortized over a suitable time period to calculate an interval payment. Once the interval payment has been calculated it can be compared to the cost of supplying energy to the community from the traditional energy system over the same interval period.

If the interval cost meets the threshold relative to the conventional energy cost then an ROI can be calculated based on this determination. In this example, the ROI could be calculated internally by the municipal government, so that a municipal government bond can be issued to procure financing for the conversion. Once the appropriate financing has been secured, the municipal government can move forward with converting the community from a regional grid providing electricity produced by nuclear power and thermal heat produced through a combination of oil and wood burning heaters to a closed, community grid providing electricity produced by the combination of a landfill biogas and a pelletized combustion facility and thermal energy produced by a district water heating system.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for financing the conversion of an entity from a traditional energy system to a self-sufficient energy system comprising the following steps:
receiving the conversion cost of the self-sufficient energy system;
receiving the energy cost of the traditional energy system, the energy cost determined over at least one interval;
amortizing the conversion cost of said self-sufficient energy system over the at least one interval to generate an amortized interval cost;
comparing the amortized interval cost to the energy cost of the traditional energy system to determine a cost ratio;
comparing the cost ratio to a predetermined cost threshold;
approving the financing of the conversion of the entity from the traditional energy system to the self-sufficient energy system if the cost ratio is less than or equal to the predetermined cost threshold; and
declining the financing of the conversion of the entity from the traditional energy system to the self-sufficient energy system, if the cost ratio is greater than the predetermined cost threshold.

2. A method of claim 1, wherein the step of comparing the amortized interval cost to the energy cost of the traditional home energy system to determine a cost ratio to determine a cost ratio includes determining return on investment.

3. A method of claim 1, wherein the entity is comprised of a plurality of entities, each of the plurality of entities selected based on a set of predetermined criteria.

4. A system for financing the conversion of an entity from a traditional energy system to a self-sufficient energy system comprising the following:
communication means configured to receive the conversion cost of the self-sufficient energy system;
communication means configured to receive the energy cost of the traditional energy system, the energy cost determined over at least one interval;
calculation means configured to amortize the conversion cost of said self-sufficient energy system over the at least one interval to generate an amortized interval cost; and
comparison means configured to evaluate the interval cost to the energy cost of the traditional energy system to determine a cost ratio with a predetermined cost threshold for approval.

5. A system of claim 5, wherein the entity is comprised of a plurality of entities, each of the plurality of entities selected based on a set of predetermined criteria.

6. A system of claim 5, wherein the calculation means is further configured to compare the amortized interval cost to the energy cost of the traditional energy system to determine a cost ratio to determine a cost ratio includes determining return on investment.
